(19) United States
(12) Patent Application Publication
(10) Pub. No.: US 2006/0084740 A1
(43) Pub. Date: Apr. 20, 2006

(54) Thermoplastic elastomer and manufacturing method thereof

(75) Inventors: Huan-Chun Kao, Kaohsiung (TW); Jau-Rong Su, Kaohsiung (TW); Yuan-Chao Tu, Kaohsiung (TW); Chien-Kun Kung, Kaohsiung (TW); Cheng-Te Lee, Kaohsiung (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: TSRC CORPORATION, Kaohsiung (TW)

(21) Appl. No.: 11/252,294

(22) Filed: Oct. 17, 2005

(30) Foreign Application Priority Data
Oct. 18, 2004 (TW) 093131564
Oct. 5, 2005 (TW) 094134878

(51) Int. Cl. C08K 3/32

(52) U.S. Cl. 524/414

(57) ABSTRACT

A low-smoke, halogen-free and flame-retardant thermoplastic elastomer is provided in the present invention. The thermoplastic elastomer includes a polymer having a hydrogenated styrenic/conjugated diene copolymer, an inorganic phosphorus flame-retardant and a flame-retardant auxiliary, wherein a weight of the hydrogenated styrenic/conjugated diene copolymer is 50-100 percents of a weight of the polymer, a weight of the inorganic phosphorus flame-retardant is ranged from 0.3 to 2 times of the weight of the hydrogenated styrenic/conjugated diene copolymer, and a weight of the flame-retardant auxiliary is ranged from 0.05 to 0.4 times of the weight of the hydrogenated styrenic/conjugated diene copolymer.

### FIELD OF THE INVENTION

The present invention relates to a thermoplastic elastomer and the manufacturing method thereof, and more particularly to a low-smoke, halogen-free and flame-retardant grade thermoplastic elastomer, which is hydrogenated styrenic/conjugated diene copolymer-based, and the manufacturing method thereof.

### BACKGROUND OF THE INVENTION

The high-molecular polymer is widely used in the daily life, and the thermoplastic elastomer is an emerging material thereof. Since the property of the thermoplastic elastomer is between the rubber and the plastic, it has not only the resilience but also the thermoplastic property for processing and become one of the most popular materials of the synthetic rubber.

Presently, the styrenic/conjugated diene copolymer is the most productive thermoplastic elastomer with its property being most similar to that of the rubber in the world. In comparison with the other thermoplastic elastomers, the styrenic/conjugated diene copolymer features a high resistance, flexibility, good resilience and low permanent deformation. Hence, it has excellent explicabilities in many fields.

The common styrenic/conjugated diene copolymer mainly includes three types in the following: the styrene butadiene styrene (SBS) copolymer, styrene-isoprene-styrene (SIS) copolymer, and the hydrogenated styrenic/conjugated diene copolymer. Among these three copolymers, since the non-hydrogenated styrene butadiene styrene copolymer and the styrene-isoprene-styrene copolymer have excellent resilience, physical properties, reasonable cost and mature formation processing technique, they are widely used and are the most popular and the fastest developed thermoplastic elastomers.

However, there are plenty of unsaturated double bonds existed in the styrene butadiene styrene copolymer or the styrene-isoprene-styrene copolymer. Hence, they have poor temperature resistance, thermal resistance and oxidation resistance. On the contrary, since the hydrogenated styrenic/conjugated diene copolymer thermoplastic elastomer have most of the unsaturated doubles bonds thereof hydrogenated (Normally, the conjugated diene of the hydrogenated styrenic/conjugated diene copolymer has the unsaturated doubles bonds thereof less than 10 percent, and in particular, the unsaturated doubles bonds thereof is less than 5 percent), it has excellent temperature resistance and good resistances of ozone, ultra-violet and electric arc. In addition, the hydrogenated styrenic/conjugated diene copolymer thermoplastic elastomer has the advantages of good compatibility with the other materials for remolding reused or recycle, complying with the Food and Drug Administration (FDA) requirements, toxic-free, odorless, good reliance, high utilization ratio per unit weight, broad: hardness range, and good insulating property and processability etc. Therefore, it is widely used in the filed of motor cars, architecture, medical devices, packing, electrical devices, electricity, communications, physical education, and consumptions etc., and the foregoing development thereof is also highly expected. However, based on'the reasons that the synthetic rubber is highly related to the daily life and the synthetic rubber being made of mainly by the carbon hydrate materials with its limiting oxygen index (LOI) being 18 is a highly inflammable combustible, it is necessary to treat the products thereof with a flame-retarding procedure.

Different flame-retarding additives, such as the inorganic metal flame-retardant, the halogen flame-retardant, the organic phosphorous flame-retardant etc., are used for preventing the products made of the synthetic rubber from inflaming. Presently, the inorganic metal flame-retardant, such as the magnesium hydroxide or the aluminum hydroxide, without the drawbacks of the halogen flame-retardant is used by most of the manufacturers. However, since its compatibility with the polymers is poor, the amount of the inorganic metal flame-retardant added must be huge (normally, the amount of the inorganic metal flame-retardant added must be greater than 50 percent in weight) for gaining the expected flame-retarding effect. This huge amount of inorganic metal flame-retardant added will reduce the mechanical properties of the material for the flame-retarding product, increase the specific weight thereof, and cause the manufactured product to have a bad scratching resistance. Hence, the inorganic metal flame-retardant is not an ideal flame-retarding additive.

As to the other kinds of flame-retardants, for example, the phosphoric acid ester, an organic phosphorous flame-retardant, as a reactive flame-retardant has the drawbacks of being toxic and the thermal-stability thereof is poor. The nitride flame-retardant, such as the melamine or the melamine cyanurate, features low-smoke and low-toxicity and has the drawbacks of poor flame-retarding effect and poor compatibility with the polymers.

Hence, the present invention is attempted to overcome the drawbacks of the prior arts and provides a thermoplastic elastomer and the manufacturing method thereof. That is to say, the present invention provides a low-smoke, halogen-free and flame-retardant grade thermoplastic elastomer and the manufacturing method thereof under the innovative concepts of giving consideration to environmental protection, safety and cost.

### SUMMARY OF THE INVENTION

It is one object of the present invention to provide a low-smoke, halogen-free and flame-retardant thermoplastic elastomer. The thermoplastic elastomer includes a polymer having a hydrogenated styrenic/conjugated diene copolymer, an inorganic phosphorus flame-retardant and a flame-retardant auxiliary, wherein a weight of the hydrogenated styrenic/conjugated diene copolymer is 50-100 percents of a weight of the polymer, a weight of the inorganic phosphorus flame-retardant is ranged from 0.3 to 2 times of the weight of the hydrogenated styrenic/conjugated diene copolymer, and a weight of the flame-retardant auxiliary is ranged from 0.05 to 0.4 times of the weight of the hydrogenated styrenic/conjugated diene copolymer.

Preferably, the hydrogenated styrenic/conjugated diene copolymer has a molecular weight ranged from 80,000 to 500,000, and a molecular distribution ranged from 1 to 3 (weight-average molecular weight/number-average molecular weight, MW/MN).

Preferably, the hydrogenated styrenic/conjugated diene copolymer has a melt flow index ranged from 0.01 to 6 dg/min, at 190° C., under a load of 5 kg, and a hardness ranged from Shore-type A 60 to 95.

Preferably, the thermoplastic elastomer further includes a processing oil for improving a melt flow ability of the thermoplastic elastomer, wherein the processing oil comprises one selected from a group consisting of a naphthenic oil, a paraffinic oil, a aromatic oil and a mixture thereof.

Preferably, the polymer further includes a polyolefin resin comprising a material selected from a group consisting of a low density polyethylene, a high density polyethylene, a linear low density polyethylene, a polypropylene, an ethylene vinyl acetate copolymer, an ethylene ethylacrylate copolymer, an ethylene butylacrylate copolymer, an ethylene methacrylate copolymer, an ethylene propylene copolymer and a mixture thereof.

Preferably, the inorganic phosphorus flame-retardant includes a material selected from a group consisting of a phosphorus, an ammonium phosphate, an ammonium polyphosphate, a melamine phosphate, a melamine pyrophosphate and a mixture thereof.

Preferably, the flame-retardant auxiliary is one of a polyalcohol or a mixture thereof for serving as a carbon source.

Preferably, the polyalcohol is one selected from a group consisting of a pentaerythritol, a di-pentaerythritol, a tris-(2-hydroxyethyl) isocyanurate and a mixture thereof.

Preferably, the flame-retardant auxiliary is one of a nitride and a mixture thereof for serving as a nitrogen source at a high temperature.

Preferably, the nitride is one of a melamine and a melamine salt.

Preferably, the melamine salt is one selected from a group consisting of a melamine cyanurate, a melamine phosphate, a melamine guanidate and a melamine dicydiamide.

Preferably, the conjugated diene is one selected from a group consisting of a 1,3-butandiene, an isoprene, a 1,3-pentadiene and a mixture thereof.

It is the other object of the present invention to provide a method for manufacturing a low-smoke, halogen-free and flame-retardant thermoplastic elastomer. The manufacturing method includes steps of: providing a first mixture, and proceeding a compounding and a shearing processes in a compounding apparatus for obtaining the low-smoke, halogen-free and flame-retardant thermoplastic elastomer, wherein the first mixture includes 100 weight parts of a hydrogenated styrenic/conjugated diene copolymer, 30 to 200 weight parts of an inorganic phosphorus flame-retardant and 5 to 40 weight parts of a flame-retardant auxiliary; the compounding process is carried out at a temperature ranged from 150° C. to 250° C.

Preferably, the method further includes steps of: providing a processing oil, and mixing the processing oil with the hydrogenated styrenic/conjugated diene copolymer at a temperature ranged from 40° C. to 70° C. before the compounding process.

Preferably, the first mixture further includes a polyolefin resin.

Preferably, the hydrogenated styrenic/conjugated diene copolymer has a molecular weight ranged from 80,000 to 500,000, a molecular distribution ranged from 1 to 3 (weight-average molecular weight/number-average molecular weight, MW/MN), a melt flow index ranged from 0.01 to 6 dg/min, at 190° C. under a load of 5 kg, and a hardness ranged from Shore-type A 60 to 95.

It is another object of the present invention to provide a low-smoke, halogen-free and flame-retardant thermoplastic elastomer. The thermoplastic elastomer includes a polymer having a hydrogenated styrenic/conjugated diene copolymer, an inorganic phosphorus flame-retardant and a flame-retardant auxiliary, wherein a weight of the hydrogenated styrenic/conjugated diene copolymer is 50-100 percents of a weight of the polymer, a weight of the inorganic phosphorus flame-retardant is ranged from 0.3 to 2 times of the weight of the hydrogenated styrenic/conjugated diene copolymer, a weight of the flame-retardant auxiliary is ranged from 0.05 to 0.4 times of the weight of the hydrogenated styrenic/conjugated diene copolymer, and the thermoplastic elastomer has a limiting oxygen index ranged from 28 to 45 and a smoke density ranged from 100 to 400 Dm, and meets the requirements of UL 94 V-0 (⅛″).

It is a further object of the present invention to provide a thermoplastic elastomer. The thermoplastic elastomer includes 100 weight part(s) of hydrogenated styrenic/conjugated diene copolymer, 150 to 250 weight part(s) of inorganic phosphorus flame-retardant, and 30 to 50 weight part(s) of a flame-retardant auxiliary.

Preferably, the thermoplastic elastomer further includes 100 to 150 weight part(s) of processing oil, and 100 to 150 weight part(s) of pol olefin resin.

It is further another object of the present invention to provide a low-smoke, halogen-free and flame-retardant thermoplastic elastomer. The thermoplastic elastomer includes 100 weight part(s) of hydrogenated styrenic/conjugated diene copolymer, 150 to 250 weight part(s) of inorganic phosphorus flame-retardant, 30 to 50 weight part(s) of a flame-retardant auxiliary, 100 to 150 weight part(s) of processing oil, and 100 to 150 weight part(s) of polyolefin resin.

Now the foregoing and other features and advantages of the present invention will be more clearly understood through the following descriptions.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purposes of illustration and description only; it is not intended to be exhaustive or to be limited to the precise form disclosed.

The hydrogenated styrenic/conjugated diene copolymer thermoplastic elastomer features an excellent temperature resistance and the good resistances of ozone, ultra-violet and electric arc. In addition, it has the advantages of good compatibility with the other materials for remolding, reused or recycling, complying with the Food and Drug Administration (FDA) requirements, toxic-free, odorless, good reliance, high utilization ratio per unit weight, broad hardness range, and good insulating property and processability. Based on those, the present invention provides a thermoplastic elastomer, which is hydrogenated styrenic/conjugated diene copolymer-based, and the manufacturing method thereof. Hence, it is not only a low-smoke, halogen-free and flame-retardant grade thermoplastic elastomer having a limiting oxygen index ranged from 28 to 45, a smoke density ranged from 100 to 400 and meeting the requirements of UL 94 V-0 (⅛″), but also a thermoplastic elastomer featuring the good flame-retarding effect, the non-sag adjustable consistency and the environmentally friendly concept.

The Hydrogenated Styrenic/Conjugated Diene Copolymer:

The preferred conjugated diene of the hydrogenated styrenic/conjugated diene copolymer in the present invention is one selected from a group consisting of a 1,3-butandiene, an isoprene, a 1,3-pentadiene and a mixture thereof, wherein the contents of the unsaturated double bounds therein is less than 10 percent, preferably, it is less than 5 percent. Certainly, the commercial hydrogenated styrenic/conjugated diene copolymer thermoplastic elastomer could be used as the hydrogenated styrenic conjugated diene copolymer in the present invention. For example, the styrene ethylene butadiene styrene (SEBS) thermoplastic elastomers of the Kraton G serious (Kraton Company), the Septon 6 serious (Kuraray Company), the Septon 8 serious (Septon Company), the SEBS serious (TSRC Company), the Calprene H 6 serious (Dynasol Company) or the Tuftec H serious (Asahi Company) could be used as a preferred hydrogenated styrenic/conjugated diene copolymer with their conjugate diene being the 1,3-butandiene in the present invention. In addition, the thermoplastic elastomers of the Dynaron serious (JSR Company) or the mixture thereof (Dynaflex serious) could be used as a preferred hydrogenated styrenic/conjugated diene partial block or random copolymer with their conjugate diene being the 1,3-butandiene in the present invention. Further, the thermoplastic elastomers of the Septon 2 serious of the Kuraray Company or the Septon Company could be used as a preferred hydrogenated styrenic/conjugated diene copolymer with their conjugate diene being the isoprene in the present invention. Furthermore, the isoprene butadiene (SEEPS) thermoplastic elastomers of the Septon 4 serious of the Kuraray Company or the Septon Company could be used as a preferred hydrogenated styrenic/conjugated diene copolymer with their conjugate diene being the mixture of the 1,3-butandiene and the isoprene in the present invention.

Preferably, before mixing with a processing oil, the synthetic or commercial hydrogenated styrenic/conjugated diene copolymer in the present invention has the following properties: the molecular weight thereof is ranged from 8 million gram per mole to 50 million gram per mole, the molecular distribution (weight-average molecular weight/number-average molecular weight, MW/MN) is ranged from 1 to 3, the melt flow index is ranged from 0.01 to 6 dg/min, at 190° C., under a load of 5 kg, the hardness is ranged from Shore-type A 60 to 95.

Except for compounding of the hydrogenated styrenic/conjugated diene copolymer, the flame-retardant and the flame-retardant auxiliary in the present invention, preferably, the hydrogenated styrenic/conjugated diene copolymer of the present invention could be mixed with a processing oil for a better processability. Preferably, the processing oil includes an oil selected from a group consisting of a naphthenic oil, a paraffinic oil, an aromatic oil and a mixture thereof.

Since the hydrogenated styrenic/conjugated diene copolymer has the excellent compatibility with the other materials, optionally, the polyolefin resin featuring its high melting point could be further added with the hydrogenated styrenic/conjugated diene copolymer, the flame-retardant and the flame-retardant auxiliary in the compounding process of the present invention for improving the thermal resistance and the physical property of the thermoplastic elastomers. The optionally added polyolefin resin includes a material selected from a group consisting of a low density polyethylene, a high density polyethylene, a linear low density polyethylene, a polypropylene, an ethylene vinyl acetate copolymer, an ethylene ethylacrylate copolymer, an ethylene butylacrylate copolymer, an ethylene methacrylate copolymer, an ethylene propylene copolymer and a mixture thereof.

Moreover, except for the hydrogenated styrenic/conjugated diene copolymer, the flame-retardant and the flame-retardant auxiliary, optionally, the antioxidant, the filling agent, the anti-static agent, the stabilizer, the color powder, the color master batch or the anti-bacterial agent could be added in the compounding process for increasing the physical or chemical properties, such as the shelf life or the attractiveness, of the thermoplastic elastomer in the present invention.

The method for manufacturing a thermoplastic elastomer according to the preferred embodiment of the present invention includes several steps. First, the hydrogenated styrenic/conjugated diene copolymer is mixed with the processing oil or the other polymers, such as the polyolefin resin, at a temperature ranged from 40° C. to 70° C. for at least 10 minutes (actually, the mixing condition is depending on the mixing apparatus used and shall not be exhaustive or be limited to the precise form disclosed). Secondly, the inorganic phosphorous flame-retardant and the flame-retardant auxiliary are added for a compounding process at a temperature of 150° C. to 250° C. (L/D=20 to 50) and a shearing processes in a compounding apparatus for forming a colloidal particle or sheet of the low-smoke, halogen-free and flame-retardant thermoplastic elastomer. Then, a further shaping process is proceeded by an extruding device or an injection molding device.

Preferably, the compounding and the shearing processes of the thermoplastic elastomer in the present invention are carried out by a banbury, a mill, a kneader, and a twin-screw extruder. The compounding materials with respective weight ratio are feed into the above-mentioned compounding apparatus for compounding and shearing. Preferably, the processing process inside the above-mentioned compounding apparatus is performed at a temperature below 250° C. According to the above embodiment of the present invention, the weight of the inorganic phosphorous flame-retardant is not lower than the 0.3 times of the weight of the hydrogenated styrenic/conjugated diene copolymer for good flame-retarding effect. In addition, the weight of the inorganic phosphorous flame-retardant is not being 2 times greater than the weight of the hydrogenated styrenic/conjugated diene copolymer for good compatibility and processability.

The thermoplastic elastomer manufactured by the method according to the preferred embodiment of the present invention is measured by several present examinations, and the properties thereof are listed in Table 1.

TABLE 1

| | Examination | Property |
|---|---|---|
| Main contents | | hydrogenated styrenic/conjugated |
| | | diene copolymer-based thermoplastic |
| | | elastomer |
| Flame Resistance | UL-94 | V-0(⅛″) |
| Limiting oxygen | JIS K 7201 | 28-45 |
| index | | |
| Smoke (Dm/flame) | ASTM E662 | 100-400 |

Accordingly, thermoplastic elastomer manufactured by the method according to the preferred embodiment of the present invention meets the requirements of UL 94 V-0 (⅛″) with the limiting oxygen index thereof ranged from 28 to 45 and the smoke density thereof ranged from 100 to 400, and it also features the excellent reliance, the small specific weight and high extensibility.

For better understanding the present invention, two comparisons and 6 examples are listed hereafter.

Comparison 1:

The commercial soft PVC is formed and shaped by the compounding apparatus. After being examined by the above-mentioned examinations, it is found that the thermoplastic elastomer of the comparison 1 meets the requirements of UL 94 V-0 (⅛″), and the limiting oxygen index and the smoke density thereof respectively equals 45 and 720.

Comparison 2:

The commercial Taipol SEBS-3151 (the melt flow indek of 0, the molecular weight ranged from 25 to 29 million gram per mole, and the hardness measured is Shore-type A 70) is used. The 100 weight part of the above-mentioned styrene ethylene butadiene styrene copolymer is mixed with the 100 weight part of the paraffinic oil (PW-90) at the temperature ranged from 50° C. to 70° C. for 24 hours for completely mixing and absorption. Then together with the 120 weight part of the polypropylene (the melt flow index measured at 180° C., under a load of 5 kg for 10 minutes is 13), the 220 weight part of the ammonium polyphosphate (APP), and an inorganic phosphorus flame-retardant, the 1 weight part of hydroxybenzenyl antioxidant (Irganox-1010 of Ciba Company), the well-mixed processing oil and hydrogenated styrenic/conjugated diene copolymer are feed in the twin-screw extruder, a composing apparatus with L/D=32, D=30 mm, 300 rpm, for compounding at the temperature of 200° C. and shearing to colloidal particle or sheet of the thermoplastic elastomer. Finally, it is shaped with the extruding device or the injection molding device at a temperature below 200° C. After being examined by the above-mentioned examinations, it is found that the thermoplastic elastomer of the comparison 2 meets the requirements of UL 94 V-0 (⅛″), and the limiting oxygen index and the smoke density thereof respectively equals 32 and 507.

### EXAMPLE 1

The 100 weight part of the styrene ethylene butadiene styrene copolymer (the melt flow index of 0, the molecular weight ranged from 25 to 29 million gram per mole, the molecular distribution ranged from 1.1 to 1.3, and the hardness measured is Shore-type A 70) is mixed with the 100 weight part of the paraffinic oil (PW-90) at the temperature ranged from 50° C. to 70° C. for 24 hours for completely mixing and absorption. Then together with the 100 weight part of the polypropylene, the 150 weight part of the ammonium polyphosphate (APP), an inorganic phosphorus flame-retardant, the 30 weight part of the di-pentaerythritol, a flame-retardant auxiliary, and the 0.2 weight part of hydroxybenzenyl antioxidant (Irganox-1010 of Ciba Company), the well-mixed processing oil and hydrogenated styrenic/conjugated diene copolymer are feed in the twin-screw extruder, a composing apparatus with L/D=32, D=30 mm, 300 rpm, for compounding at the temperature of 200° C. and shearing to colloidal particle or sheet of the thermoplastic elastomer. Finally, it is shaped with the extruding device or the injection molding device at a temperature below 200° C. After being examined by the above-mentioned examinations, it is found that the thermoplastic elastomer of the example 1 meets the requirements of UL 94 V-0 (⅛″), and the limiting oxygen index and the smoke density thereof respectively equals 31 and 183.

### EXAMPLE 2

The commercial Taipol SEBS-3150 (the molecular weight is ranged from 9 to 11 million gram per mole, and the Styrene thereof is ranged from 29-31%) is used. The 100 weight part of the above-mentioned styrene ethylene butadiene styrene copolymer together with the 55 weight part of the ammonium polyphosphate (APP), an inorganic phosphorus flame-retardant, the 15 weight part of the di-pentaerythritol, a flame-retardant auxiliary, and the 1 weight part of hydroxybenzenyl antioxidant (Irganox-1010 of Ciba Company) are feed in the twin-screw extruder, a composing apparatus with L/D=32, D=30 mm, 300 rpm, for compounding at the temperature ranged from 150° C. to 180° C. and shearing to colloidal particle or sheet of the thermoplastic elastomer. Finally, it is shaped with the extruding device or the injection molding device at a temperature below 180° C. After being examined by the above-mentioned examinations, it is found that the thermoplastic elastomer of the example 2 meets the requirements of UL 94 V-0 (⅛″), and the limiting oxygen index and the smoke density thereof respectively equals 31 and 268.

### EXAMPLE 3

The commercial Septon-4033 of Kuraray Company (the molecular weight is ranged from 7 to 10 million gram per mole, and the Styrene thereof is ranged from 29-31%) is used. The 100 weight part of the above-mentioned isoprene butadiene copolymer together with the 55 weight part of the melamine pyrophosphate (MPP), an inorganic phosphorus flame-retardant, the 15 weight part of the tris-(2-hydroxyethyl) isocyanurate (THEIC), and a flame-retardant auxiliary, the 0.2 weight part of hydroxybenzenyl antioxidant (Irganox-1010 of Ciba Company) are feed in the twin-screw extruder, a composing apparatus with L/D=32, D=30 mm, 300 rpm, for compounding at the temperature ranged from 150° C. to 180° C. and shearing to colloidal particle or sheet of the thermoplastic elastomer. Finally, it is shaped with the extruding device or the injection molding device at a temperature below 180° C. After being examined by the above-mentioned examinations, it is found that the thermoplastic elastomer of the example 2 meets the requirements of UL 94 V-0 (⅛″), and the limiting oxygen index and the smoke density thereof respectively equals 31 and 272.

### EXAMPLE 4

The commercial Taipol SEBS-3150 (the molecular weight is ranged from 9 to 11 million gram per mole, and the Styrene thereof is ranged from 29-31%) is used. The 100 weight part of the above-mentioned styrene ethylene butadiene styrene copolymer together with the 70 weight part of the ammonium polyphosphate (APP), an inorganic phosphorus flame-retardant, the 10 weight part of the di-pentaerythritol, a flame-retardant auxiliary, and the 0.2 weight part of hydroxybenzenyl antioxidant (Irganox-1010 of Ciba Company) are feed in the twin-screw extruder, a composing apparatus with L/D=32, D=30 mm, 300 rpm, for compounding at the temperature ranged from 150° C. to 180° C. and shearing to colloidal particle or sheet of the thermoplastic elastomer. Finally, it is shaped with the extruding device or the injection molding device at a temperature below 180° C. After being examined by the above-mentioned examinations, it is found that the thermoplastic elastomer of the example 2 meets the requirements of UL 94 V-0 (⅛″), and the limiting oxygen index and the smoke density thereof respectively equals 33 and 244.

### EXAMPLE 5

The commercial Septon-4033 of Kuraray Company (the molecular weight is ranged from 7 to 10 million gram per mole, and the Styrene thereof is ranged from 29-31%) is used. The 100 weight part of the above-mentioned isoprene butadiene copolymer together with the 40 weight part of the ammonium polyphosphate (APP), an inorganic phosphorus flame-retardant, the 20 weight part of the di-pentaerythritol, a flame-retardant auxiliary, and the 0.2 weight part of hydroxybenzenyl antioxidant (Irganox-1010 of Ciba Company) are feed in the twin-screw extruder, a composing apparatus with L/D=32, D=30 mm, 300 rpm, for compounding at the temperature ranged from 150° C. to 180° C. and shearing to colloidal particle or sheet of the thermoplastic elastomer. Finally, it is shaped with the extruding device or the injection molding device at a temperature below 180° C. After being examined by the above-mentioned examinations, it is found that the thermoplastic elastomer of the example 2 meets the requirements of UL 94 V-0 (⅛″), and the limiting oxygen index and the smoke density thereof respectively equals 30 and 291.

### EXAMPLE 6

The mixture of 40 weight part of the commercial Taipol SEBS-3151 (the melt flow index of 0, the molecular weight ranged from 25 to 29 million gram per mole) and 60 weight part of the commercial Taipol SEBS-3150 is mixed with the 100 weight part of the paraffinic oil (PW-90) at the temperature ranged from 50° C. to 70° C. for 24 hours for completely mixing and absorption. Then together with the 100 weight part of the ammonium polyphosphate (APP), an inorganic phosphorus flame-retardant, the 5 weight part of the di-pentaerythritol, a flame-retardant auxiliary, and the 1 weight part of hydroxybenzenyl antioxidant (Irganox-1010 of Ciba Company), the well-mixed processing oil and hydrogenated styrenic/conjugated diene copolymer are feed in the twin-screw extruder a composing apparatus with L/D=32, D=30 mm, 300 rpm, for compounding at the temperature ranged from 150° C. to 180° C. and shearing to colloidal particle or sheet of the thermoplastic elastomer. Finally, it is shaped with the extruding device or the injection molding device at a temperature below 180° C. After being examined by the above-mentioned examinations, it is found that the thermoplastic elastomer of the example 2 meets the requirements of UL 94 V-0 (⅛″), and the limiting oxygen index and the smoke density thereof respectively equals 39 and 297.

As mentioned above, in addition to the paraffinic oil, the processing oil could also be the aromatic oil, the naphthenic oil or the mixture of the mentioned oils. Among the processing oils, the naphthenic oil is the most preferred processing oil due to its excellent compatibility with the styrene ethylene butadiene styrene. Although the color of the aromatic oil is poor, it is another preferred processing oil with good compatibility with the other polymer. The paraffinic oil features its good color and sub-optimized compatibility and is the third preferred processing oil in the present invention.

Similarly, although only the ammonium polyphosphate (APP) and the melamine pyrophosphate (MPP) are used in the above examples, the inorganic phosphorus flame-retardant in the present invention includes a material selected from a group consisting of the phosphorus, the ammonium phosphate, the ammonium polyphosphate, the melamine phosphate, the melamine pyrophosphate and the mixture thereof.

Accordingly, although only the di-pentaerythritol and the tris-(2-hydroxyethyl) isocyanurate are used in the above examples, the flame-retardant auxiliary in the present invention includes a material selected from a group consisting of the pentaerythritol, the di-pentaerythritol, the tris-(2-hydroxyethyl) isocyanurate, the melamine cyanurate, the melamine phosphate, the melamine guanidate, the melamine dicydiamide and the mixture thereof.

Compared with the prior art, the present invention provides a thermoplastic elastomer and the manufacturing method thereof, wherein the innovative low-smoke, halogen-free and flame-retardant grade thermoplastic elastomer gives consideration to environmental protection, safety and cost. Therefore, the present invention can solve the drawbacks of the prior art and is thus practicable.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

1. A low-smoke, halogen-free and flame-retardant thermoplastic elastomer, comprising:
a polymer having a hydrogenated styrenic/conjugated diene copolymer;
an inorganic phosphorus flame-retardant; and
a flame-retardant auxiliary, wherein a weight of said hydrogenated styrenic/conjugated diene copolymer is 50-100 percents of a weight of said polymer, a weight of said inorganic phosphorus flame-retardant is ranged from 0.3 to 2 times of said weight of said hydrogenated styrenic/conjugated diene copolymer, and a weight of said flame-retardant auxiliary is ranged from 0.05 to 0.4 times of said weight of said hydrogenated styrenic/conjugated diene copolymer.

2. The thermoplastic elastomer according to claim 1, wherein said hydrogenated styrenic/conjugated diene copolymer has a molecular weight ranged from 80,000 to 500,000, and a molecular distribution ranged from 1 to 3 (weight average molecular weight/number-average molecular weight, MW/MN).

3. The thermoplastic elastomer according to claim 2, wherein said hydrogenated styrenic/conjugated diene copolymer has a melt flow index ranged from 0.01 to 6 dg/min, at 190° C., under a load of 5 kg, and a hardness ranged from Shore type A 60 to 95.

4. The thermoplastic elastomer according to claim 1 further comprising a processing oil for improving a melt flow ability of said thermoplastic elastomer, wherein said processing oil comprises one selected from a group consisting of a naphthenic oil, a paraffinic oil, a aromatic oil and a mixture thereof.

5. The thermoplastic elastomer according to claim 1, wherein said polymer further comprises a polyolefin resin comprising a material selected from a group consisting of a low density polyethylene, a high density polyethylene, a linear low density polyethylene, a polypropylene, an ethylene vinyl acetate copolymer, an ethylene ethylacrylate copolymer, an ethylene butylacrylate copolymer, an ethylene methacrylate copolymer, an ethylene propylene copolymer and a mixture thereof.

6. The thermoplastic elastomer according to claim 1, wherein said inorganic phosphorus flame-retardant comprises a material selected from a group consisting of a phosphorus, an ammonium phosphate, an ammonium polyphosphate, a melamine phosphate, a melamine pyrophosphate and a mixture thereof.

7. The thermoplastic elastomer according to claim 1, wherein said flame-retardant auxiliary is one of a polyalcohol or a mixture thereof for serving as a carbon source.

8. The thermoplastic elastomer according to claim 7, wherein said polyalcohol is one selected from a group consisting of a pentaerythritol, a di-pentaerythritol, a tris-(2-hydroxyethyl) isocyanurate and a mixture thereof.

9. The thermoplastic elastomer according to claim 1, wherein said flame-retardant auxiliary is one of a nitride and a mixture thereof for serving as a nitrogen source at a high temperature.

10. The thermoplastic elastomer according to claim 9, wherein said nitride is one of a melamine and a melamine salt.

11. The thermoplastic elastomer according to claim 10, wherein said melamine salt is one selected from a group consisting of a melamine cyanurate, a melamine phosphate, a melamine guanidate and a melamine dicydiamide.

12. The thermoplastic elastomer according to claim 1, wherein said conjugated diene is one selected from a group consisting of a 1,3-butandiene, an isoprene, a 1,3-pentadiene and a mixture thereof.

13. A method for manufacturing a low-smoke, halogen-free and flame-retardant thermoplastic elastomer, comprising steps of:
(a) providing a first mixture comprising:
100 weight parts of a hydrogenated styrenic/conjugated diene copolymer,
30 to 200 weight parts of an inorganic phosphorus flame-retardant and
5 to 40 weight parts of a flame-retardant auxiliary; and
(b) proceeding a compounding and a shearing processes in a compounding apparatus for obtaining said low-smoke, halogen-free and flame-retardant thermoplastic elastomer,
wherein said compounding process is carried out at a temperature ranged from 150° C. to 250° C.

14. The method according to claim 13 further comprising steps of:
providing a processing oil; and
mixing said processing oil with said hydrogenated styrenic/conjugated diene copolymer at a temperature ranged from 40° C. to 70° C. before said compounding process.

15. The method according to claim 14, wherein said first mixture further comprises a polyolefin resin.

16. The method according to claim 13, wherein said hydrogenated styrenic/conjugated diene copolymer has a molecular weight ranged from 80,000 to 500,000, a molecular distribution ranged from 1 to 3 (weight-average molecular weight/number-average molecular weight, Mw/MN), a melt flow index ranged from 0.01 to 6 dg/min, at 190° C., under a load of 5 kg, and a hardness ranged from Shore-type A 60 to 95.

17. A low-smoke, halogen-free and flame-retardant thermoplastic elastomer, comprising:
a polymer having a hydrogenated styrenic/conjugated diene copolymer;
an inorganic phosphorus flame-retardant; and
a flame-retardant auxiliary,
wherein a weight of said hydrogenated styrenic/conjugated diene copolymer is 50-100 percents of a weight of said polymer, a weight of said inorganic phosphorus flame-retardant is ranged from 0.3 to 2 times of said weight of said hydrogenated styrenic/conjugated diene copolymer, and a weight of said flame-retardant auxiliary is ranged from 0.05 to 0.4 times of said weight of said hydrogenated styrenic/conjugated diene copolymer, and said thermoplastic elastomer has a limiting oxygen index ranged from 28 to 45 and a smoke density ranged from 100 to 400 Dm, and meets the requirements of UL 94 V-0 (⅛″).

18. A thermoplastic elastomer, comprising:
100 weight part(s) of hydrogenated styrenic/conjugated diene copolymer;
150 to 250 weight part(s) of inorganic phosphorus flame-retardant; and
30 to 50 weight part(s) of a flame-retardant auxiliary.

19. The thermoplastic elastomer according to claim 18 further comprising:
100 to 150 weight part(s) of processing oil; and
100 to 150 weight part(s) of polyolefin resin.

20. A low-smoke, halogen-free and flame-retardant thermoplastic elastomer, comprising:
100 weight part(s) of hydrogenated styrenic/conjugated diene copolymer;
150 to 250 weight part(s) of inorganic phosphorus flame-retardant;
30 to 50 weight part(s) of a flame-retardant auxiliary;
100 to 150 weight part(s) of processing oil; and
100 to 150 weight part(s) of polyolefin resin,
wherein said thermoplastic elastomer has a limiting oxygen index ranged from 28 to 45 and a smoke density ranged from 100 to 400, and meets the requirements of UL 94 V-0 (⅛″).
